(19) United States
(12) Patent Application Publication
(10) Pub. No.: US 2017/0248869 A1
(43) Pub. Date: Aug. 31, 2017

(54) DEVELOPING CARTRIDGE AND IMAGE FORMING APPARATUS

(71) Applicant: CANON KABUSHIKI KAISHA, Tokyo (JP)

(72) Inventors: Kazuki Matsumoto, Fuji-shi (JP); Teruhiko Sasaki, Mishima-shi (JP); Daisuke Makiguchi, Izunokuni-shi (JP); Kazutaka Sueshige, Susono-shi (JP); Masato Tanabe, Susono-shi (JP)

(21) Appl. No.: 15/440,064

(22) Filed: Feb. 23, 2017

(30) Foreign Application Priority Data
Feb. 29, 2016 (JP) 2016-037094
Feb. 15, 2017 (JP) 2017-026447

(51) Int. Cl. G03G 15/04

(52) U.S. Cl. CPC G03G 15/0865; G03G 21/1647

(57) ABSTRACT

A developing cartridge, to be used in an image forming apparatus in which the developing cartridge including a developer carrier and a drum cartridge including a photosensitive drum are attachable and detachable, includes a cartridge body including the developer carrier, first and second supporting members that support the cartridge body to be capable of turning, and a restricting member that restricts the turn of the cartridge body with respect to the first supporting member in the developing cartridge in which the first and second supporting members have been positioned in the body of the image forming apparatus and urging has been made possible in one direction in a turning direction of the cartridge body so that the developing roller is made capable of coming into contact with the photosensitive drum, when the developing cartridge has been attached to the image forming apparatus.

### BACKGROUND OF THE INVENTION

Field of the Invention

This invention relates to a cartridge that is attachable to and detachable from the body of an image forming apparatus and an image forming apparatus that forms an image on a recording medium using electrophotographic technology.

Description of the Related Art

Conventionally, in an electrophotographic image forming apparatus using electrophotographic technology, a photosensitive drum is first uniformly charged by a charge roller. The charged photosensitive drum is exposed by an exposure device to form an electrostatic latent image on the photosensitive drum. The electrostatic latent image formed on the photosensitive drum is developed as a toner image by a developing device. The toner image formed on the photosensitive drum is transferred onto a sheet such as paper. The toner image transferred onto the sheet is heated and pressurized by a fixing device to fix the toner image on the sheet. Accordingly, an image is formed on the sheet.

Generally, in recent years, a photosensitive drum, a charge roller, and a developing device have been integrated as a process cartridge. Since a process cartridge is attachable to and detachable from the body of an image forming apparatus, a toner refill for the process cartridge or replacement of a photosensitive drum, developing roller, or the like can be done by replacing the process cartridge. Therefore, by using such a process cartridge design, maintenance or the like of parts within an image forming apparatus can be performed by a user.

An electrostatic latent image formed on a photosensitive drum is developed by a toner being supplied from a developing roller provided to a developing device. When developing the electrostatic latent image on the photosensitive drum, the developing roller and the photosensitive drum are in contact. However, when the developing roller and the photosensitive drum are in contact for a long period of time, a resulting deformation of the developing roller may deteriorate the quality of an image formed on a sheet. Thus, in a conventional technique, a developing roller and a photosensitive drum are caused to make contact only in the case of forming an image on a sheet, in order to prevent a deformation of the developing roller. In the case of not forming an image on a sheet, the developing roller and the photosensitive drum are separated.

In a technique disclosed in Japanese Patent Application Laid-open No. S63-100481, a developing cartridge including a developing roller and a drum cartridge including a photosensitive drum are each separately capable of being attached and detached with respect to the body of an image forming apparatus. In a state where the developing cartridge and the drum cartridge have been attached to the body, the developing roller and the photosensitive drum can be caused to come into contact or separate. In a state where the developing roller and the photosensitive drum are in contact, an electrostatic latent image on the photosensitive drum is developed by a toner adhering to the developing roller. In the technique disclosed in Japanese Patent Application Laid-open No. S63-100481, the developing roller is urged toward the photosensitive drum by biasing means such as a spring, in a state where the developing roller and the photosensitive drum are in contact.

However, in the case where a jam (sheet jam) has occurred within the image forming apparatus, the drum cartridge may have to be detached from the body, in a state where the photosensitive drum and the developing roller are in contact. In this case, the developing roller is urged by the biasing means toward where the photosensitive drum has been located, even though the drum cartridge is detached from the body. Therefore, there is a risk of the developing roller being damaged, by the developing roller making contact with a member within the body.

### SUMMARY OF THE INVENTION

An object of the present invention is to prevent a developer carrier such as a developing roller from being damaged.

In order to achieve the above object, a developing cartridge according to the present invention is a developing cartridge made capable, together with a drum cartridge including a photosensitive drum, of being each attached to and detached from an image forming apparatus, and including a developer carrier, the developing cartridge comprising:

a cartridge body including the developer carrier;

a first supporting member provided to one end of the developer carrier in an axial direction and a second supporting member provided to another end in the axial direction to support the cartridge body to be capable of turning, such that the developer carrier is made capable of coming into contact with the photosensitive drum; and

a restricting member that restricts a turn of the cartridge body with respect to the first supporting member, when the developing cartridge has been attached to the image forming apparatus, the first supporting member and the second supporting member have been positioned in a body of the image forming apparatus, and the cartridge body has been urged in one direction in a turning direction.

The present invention can prevent a developer carrier such as a developing roller from being damaged.

Further features of the present invention will become apparent from the following description of exemplary embodiments with reference to the attached drawings.

### BRIEF DESCRIPTION OF THE DRAWINGS

FIG. 1 is an external perspective view of a developing device according to an embodiment;

FIG. 2 is a schematic sectional view of an image forming apparatus according to the embodiment;

FIG. 3 is an external perspective view of a drum cartridge according to the embodiment;

FIG. 4 is a schematic sectional view of the drum cartridge according to the embodiment;

FIG. 5 is a schematic sectional view of the developing device according to the embodiment;

FIG. 6 is an exploded view of the developing device according to the embodiment;

FIG. 7 is a view showing the attachment of the developing device and the drum cartridge;

FIG. 8 is a view showing a state where the developing device has been positioned with respect to the body of the image forming apparatus;

FIGS. 9A and 9B are views showing a developing roller and a photosensitive drum separating;

FIGS. 10A and 10B are views showing the developing roller and the photosensitive drum coming into contact; and

FIG. 11 is a view showing the configuration of a developing frame body in the developing device according to the embodiment.

### DESCRIPTION OF THE EMBODIMENTS

Modes for carrying out the present invention are illustratively explained in detail below on the basis of embodiment with reference to the drawings. However, dimensions, materials, and shapes of components described in the embodiments, relative arrangement of the components, and the like should be changed as appropriate according to the configuration of an apparatus to which the invention is applied and various conditions. That is, the dimensions, the materials, the shapes, and the relative arrangement are not intended to limit the scope of the present invention to the embodiments.

<Overall Configuration of Image Forming Apparatus>

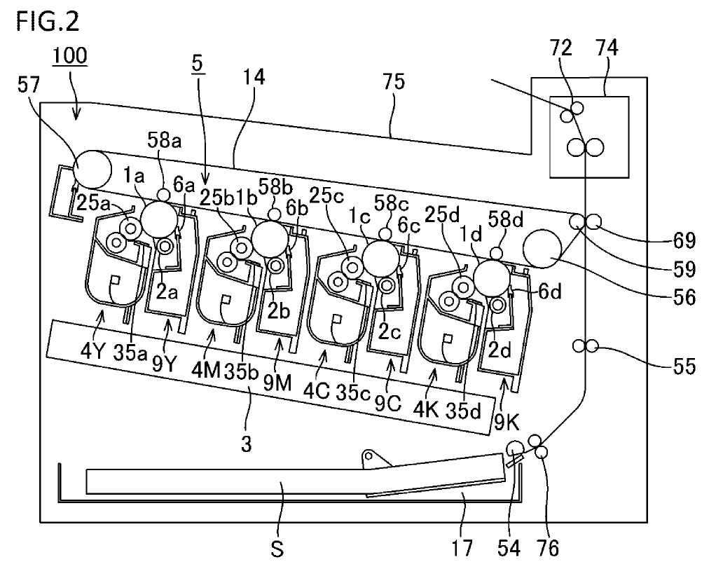

First, the overall configuration of an electrophotographic image forming apparatus 100 (hereinafter referred to as image forming apparatus 100) will be described using FIG. 2. FIG. 2 is a schematic sectional view of the image forming apparatus 100 according to an embodiment. As shown in FIG. 2, four drum cartridges 9 (9Y, 9M, 9C, and 9K) capable of being attached and detached and four developing devices 4 (4Y, 4M, 4C, and 4K) as a cartridge are attached to the image forming apparatus 100 by an attachment member (not shown). Herein, the upstream side in the direction of attachment of the drum cartridge 9 and the developing device 4 with respect to the body of the image forming apparatus 100 is defined as the near side, and the downstream side in the direction of attachment is defined as the far side. In FIG. 2, the drum cartridge 9 and the developing device 4 are provided together in a direction inclined from the horizontal direction, with respect to the body of the image forming apparatus 100.

Arranged in the drum cartridge 9 are a photosensitive drum 1 (image carrier) (1a, 1b, 1c, or 1d) and a charge roller 2 (2a, 2b, 2c, or 2d) arranged in the periphery of the photosensitive drum 1. In the drum cartridge 9, a cleaning member 6 (6a, 6b, 6c, or 6d) is arranged. In the drum cartridge 9, process means such as the photosensitive drum 1, the charge roller 2, and the cleaning member 6 are arranged integrally. In the developing device 4 (4Y, 4M, 4C, or 4K) as a cartridge, process means such as a developing roller 25 (developer carrier) (25a, 25b, 25c, or 25d) and a developing blade 35 (35a, 35b, 35c, or 35d) are arranged integrally.

The charge roller 2 uniformly charges the surface of the photosensitive drum 1, and the developing roller 25 carries a toner as a developer for developing an electrostatic latent image formed on the photosensitive drum 1. The cleaning member 6 removes a toner remaining on the photosensitive drum 1 after a toner image (developer image) formed on the photosensitive drum 1 has been transferred onto a recording medium. Below the drum cartridge 9 and the developing device 4, a scanner unit 3 is provided for forming an electrostatic latent image on the photosensitive drum 1 by selectively exposing the photosensitive drum 1 on the basis of image information.

In the lower part of the body of the image forming apparatus 100, a cassette 17 accommodating a recording medium S is attached. Conveying means is provided for conveying the recording medium S to above the image forming apparatus 100 past a secondary transfer roller 69 and a fixing device 74. The image forming apparatus 100 is provided with a feeding roller 54 that separates and feeds the recording medium. S within the cassette 17, one sheet at a time, and a conveying roller pair 76 that conveys the fed recording medium S. The image forming apparatus 100 is provided with a resist roller pair 55 for synchronization of an electrostatic latent image formed on the photosensitive drum 1 and the recording medium S.

Above the drum cartridge 9 and the developing device 4, an intermediate transfer unit 5 is provided as intermediate transfer means for transferring a toner image formed on the photosensitive drum 1 (1a, 1b, 1c, or 1d) onto the recording medium S. The intermediate transfer unit 5 includes a driving roller 56, a driven roller 57, and primary transfer rollers 58 (58a, 58b, 58c, and 58d) provided in positions opposing the photosensitive drums 1 of respective colors. The intermediate transfer unit 5 includes an opposing roller 59 provided in a position opposing the secondary transfer roller 69. A transfer belt 14 is stretched across by the driving roller 56, the driven roller 57, the primary transfer rollers 58, and the opposing roller 59. The transfer belt 14 circulates to oppose and make contact with all of the photosensitive drums 1. The primary transfer roller 58 (58a, 58b, 58c, or 58d) is applied with a voltage for a primary transfer of a toner image from the photosensitive drum 1 onto the transfer belt 14. The opposing roller 59 arranged on the inner circumferential surface side of the transfer belt 14 and the secondary transfer roller 69 are applied with a voltage for a secondary transfer, onto the recording medium S, of a toner image after the primary transfer onto the transfer belt 14.

As described above, in the case of forming a toner image on the photosensitive drum 1, the rotating photosensitive drum 1 is charged by the charge roller 2. Next, the photosensitive drum 1 uniformly charged by the charge roller 2 is selectively exposed by the scanner unit 3 to form an electrostatic latent image on the photosensitive drum 1. The electrostatic latent image formed on the photosensitive drum 1 is developed by a toner supplied from the developing roller 25. Accordingly, toner images of the respective colors are formed on the respective photosensitive drums 1. In synchronization with the operation of forming the toner image on the photosensitive drum 1, the resist roller pair 55 conveys the recording medium S to a secondary transfer position that is a position in which the opposing roller 59 and the secondary transfer roller 69 are in contact via the transfer belt 14. The secondary transfer roller 69 is applied with a transfer bias voltage for the secondary transfer of the toner images of the respective colors on the transfer belt 14 onto the recording medium S. Accordingly, a color toner image is formed on the recording medium S. The recording medium S onto which the color toner image has been transferred is heated and pressurized by the fixing device 74 to fix the toner image on the recording medium S. Then, the recording medium S is discharge to a discharge portion 75 by a discharging roller 72. The fixing device 74 is arranged in the upper part of the image forming apparatus 100.

<Drum Cartridge>

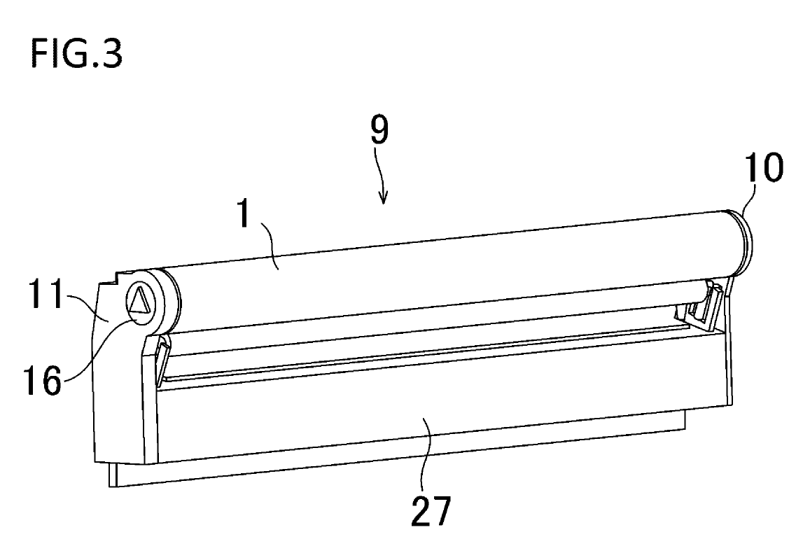

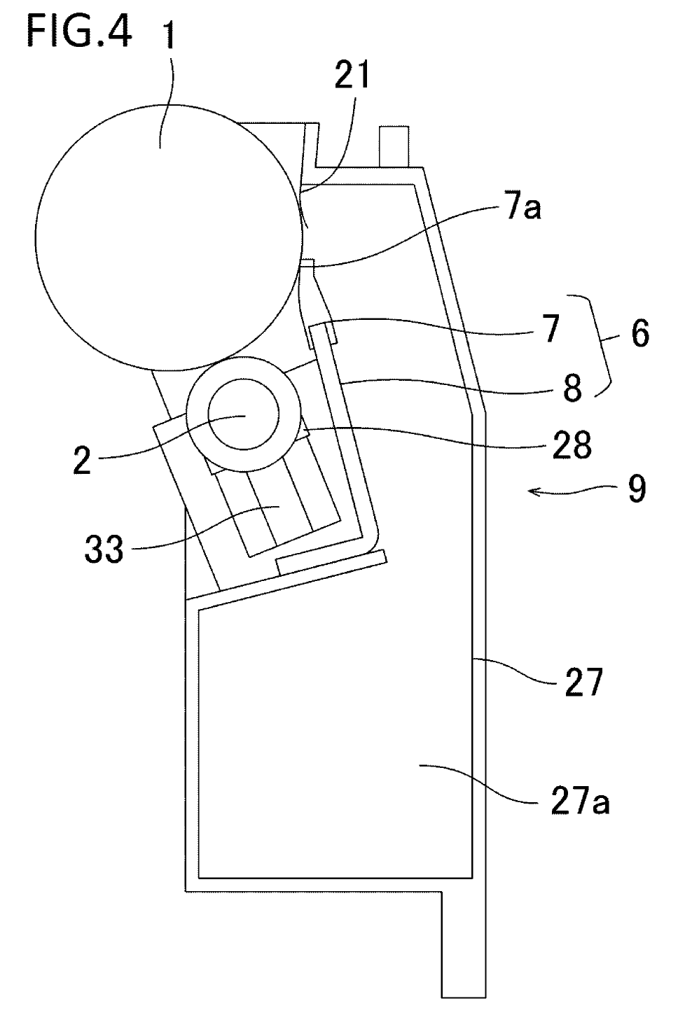

Next, the drum cartridge 9 according to this embodiment will be described using FIGS. 3 and 4. FIG. 3 is an external perspective view of the drum cartridge 9 according to the embodiment. FIG. 4 is a schematic sectional view of the drum cartridge 9 according to the embodiment. In this embodiment, the configurations of the drum cartridges 9 (9Y, 9M, 9C, and 9K) are configurations similar to one another. To a cleaning frame body 27 of the drum cartridge 9 (9Y, 9M, 9C or 9K), the photosensitive drum 1 is rotatably supported by a near drum bearing 10 and a far drum bearing 11. At one end side in the direction of the central axis of rotation of the photosensitive drum 1, a drum coupling 16 and a flange, not shown, are provided.

In the periphery of the photosensitive drum 1, as described above, the charge roller 2 and the cleaning member 6 are provided. The cleaning member 6 is configured of a rubber blade 7 formed of an elastic material and a cleaning support member 8. A tip end portion 7a of the rubber blade 7 is in contact with the photosensitive drum 1 in a direction against the rotating direction of the photosensitive drum 1. A residual toner removed from the surface of the photosensitive drum 1 by the cleaning member 6 falls to a removed toner chamber 27a. A sheet member 21 for preventing a removed toner within the removed toner chamber 27a from coming out is in contact with the photosensitive drum 1. A drive force is transmitted to the drum cartridge 9 from a body driving motor (not shown) that is a drive source to rotate and drive the photosensitive drum 1 in accordance with an image forming operation. The charge roller 2 is attached, to be capable of rotating, to the drum cartridge 9 via a charge roller bearing 28 and pressurized against the photosensitive drum 1 by a charge-roller pressurizing member 33. The charge roller 2 is rotated in accordance with the photosensitive drum 1.

<Developing Device>

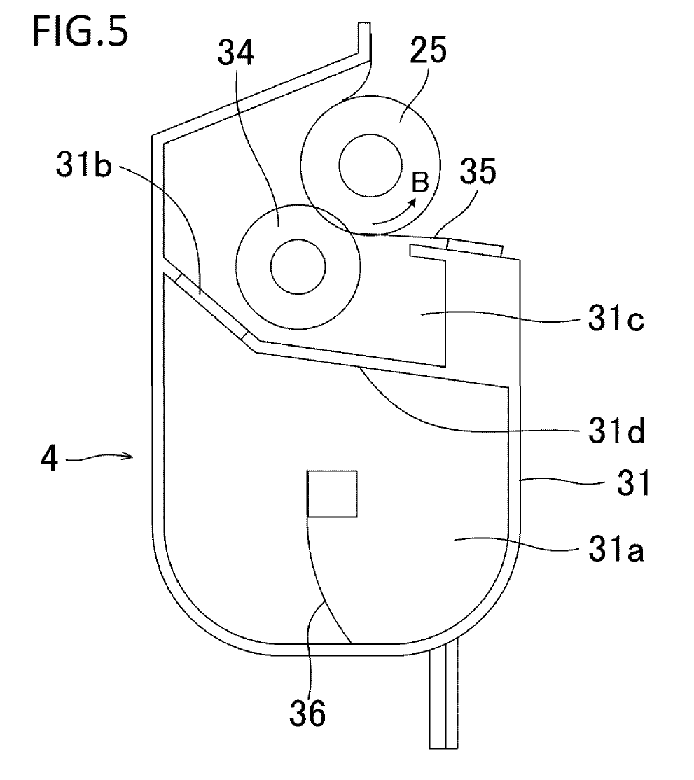

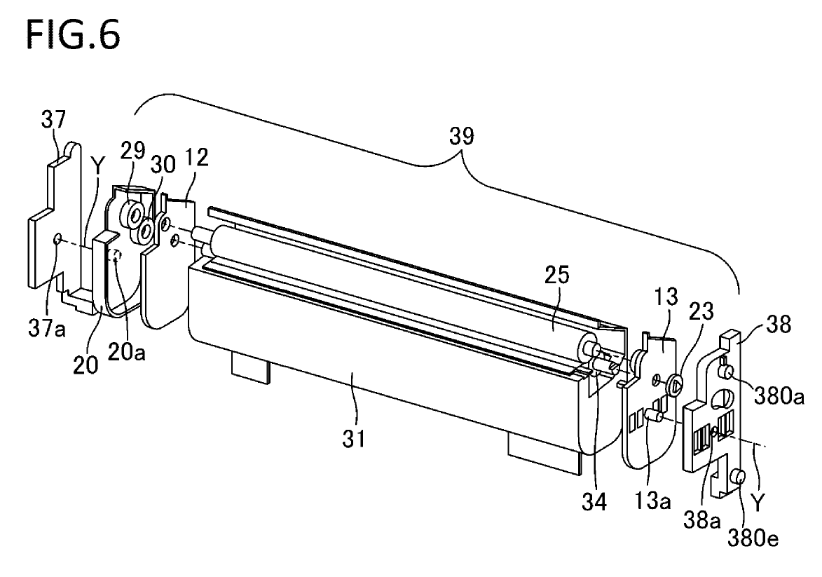

Next, the developing device 4 as a cartridge will be described using FIGS. 5 and 6. FIG. 5 is a schematic sectional view of the developing device 4 according to the embodiment. FIG. 6 is an exploded view of the developing device according to the embodiment. The developing device 4Y accommodating a yellow toner, the developing device 4M accommodating a magenta toner, the developing device 4C accommodating a cyan toner, and the developing device 4K accommodating a black toner are the same in configuration. The developing device 4 includes the developing roller 25 that rotates in an arrow B direction while making contact with the photosensitive drum 1. The developing device 4 includes a toner supply roller 34 that rotates while making contact with the developing roller 25 and the developing blade 35 for restricting a toner layer on the developing roller 25. The developing device 4 includes, in addition to a toner conveying member 36, a developing frame body 31 that supports the developing roller 25, the toner supply roller 34, the developing blade 35, and the toner conveying member 36.

The developing frame body 31 includes a developing chamber 31c in which the developing roller 25 is arranged and a toner accommodating chamber 31a provided below the developing chamber 31c. The toner accommodating chamber 31a of the developing frame body 31 is provided with the toner conveying member 36 for stirring accommodated toners and conveying the toner to the developing chamber 31c from the toner accommodating chamber 31a via an opening portion 31b. The toner accommodating chamber 31a and the developing chamber 31c are partitioned by a partition wall 31d. The partition wall 31d is provided with the opening portion 31b so that the toner is conveyed to the developing chamber 31c from the toner accommodating chamber 31a.

As shown in FIG. 6, the developing roller 25 and the toner supply roller 34 are rotatably supported by a near developing bearing 12 and a far developing bearing 13 as apart of the developing frame body 31, at two sides in the direction of the central axis of rotation of the developing roller 25. At the far-side end portion of the toner supply roller 34, a developing coupling 23 is provided. At the near-side end portion of the toner supply roller 34, a toner supply gear 30 is provided. At the near-side end portion of the developing roller 25, a developing gear 29 that meshes with the toner supply gear 30 is provided. Therefore, by the drive force of the body driving motor (not shown) that is a drive source being transmitted to the developing coupling 23, the toner supply roller 34 and the developing roller 25 are rotated and driven in accordance with an image forming operation. On the outside of the developing gear 29 and the toner supply gear 30, a gear cover 20 as a part of the developing frame body 31 is provided.

At two end sides of the developing frame body 31 in the direction of the central axis of rotation of the developing roller 25, a near-side end portion member 37 and a far-side end portion member 38 as a supporting member are provided. The far-side end portion member 38 is provided with a lifting hole 38a that engages with a boss 13a provided to the far developing bearing 13. The near-side end portion member 37 is provided with a lifting hole 37a that engages with a boss 20a provided to the gear cover 20. The near-side end portion member 37 and the far-side end portion member 38 are attached to be rotatable with respect to a central axis of rotation Y connecting the boss 13a of the far developing bearing 13 and the boss 20a of the gear cover 20. The central axis of rotation Y of a developing unit 39 as a cartridge body is parallel to the central axis of rotation of the developing roller 25. In this embodiment, the developing unit 39 includes the developing frame body 31 including the far developing bearing 13 that engages with the far-side end portion member 38, the gear cover 20 that engages with the near-side end portion member 37, and the near developing bearing 12. With the configuration described above, the developing unit 39 is made rotatable with respect to the near-side end portion member 37 and the far-side end portion member 38.

<Configuration to Attach or Detach Drum Cartridge 9 and Developing Device 4>

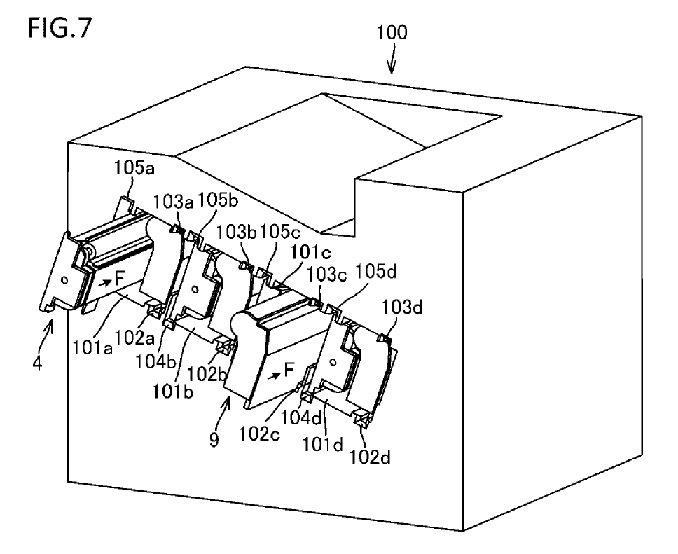

Next, using FIG. 7, the operation of inserting the developing device 4 as a cartridge and the drum cartridge 9 to the image forming apparatus 100 will be described. In this embodiment, the drum cartridge 9 and the developing device 4 are inserted to an opening portion 101 (101a, 101b, 101c, or 101d) of the image forming apparatus 100, in a direction (an arrow F direction in FIG. 7) parallel to the direction of the central axis of rotation of the photosensitive drum 1. The drum cartridge 9 and the developing device 4 are inserted to the body of the image forming apparatus 100 toward the far side from the near side.

In the upper part of the image forming apparatus 100, body attachment upper guide portions 103 (103a, 103b, 103c, and 103d) that are first body guide portions are provided. In the lower part of the image forming apparatus 100, body attachment lower guide portions 102 (102a, 102b, 102c, and 102d) that are second body guide portions are provided. The body attachment upper guide portion 103 and the body attachment lower guide portion 102 are each a guide of the drum cartridge 9 extending along the arrow F direction. In the case of inserting the drum cartridge 9 to the image forming apparatus 100, the drum cartridge 9 is first placed, on the upstream side of the arrow F direction, on the body attachment lower guide portion 102. In that state, the drum cartridge 9 is moved in the arrow F direction along the body attachment upper guide portion 103 and the body attachment lower guide portion 102. In this manner, the drum cartridge 9 is inserted to the body of the image forming apparatus 100.

A case of inserting the developing device 4 to the body of the image forming apparatus 100 is similar to that with the drum cartridge 9. First, in the arrow F direction, the developing device 4 is placed on the upstream side of a body attachment lower guide portion 104 (104a, 104b, 104c, or 104d) provided to the lower part of the body of the image forming apparatus 100. In the arrow F direction, the developing device 4 is moved along a body attachment upper guide portion 105 (105a, 105b, 105c, or 105d) and the body attachment lower guide portion 104. Accordingly, the developing device 4 is inserted to the body of the image forming apparatus 100.

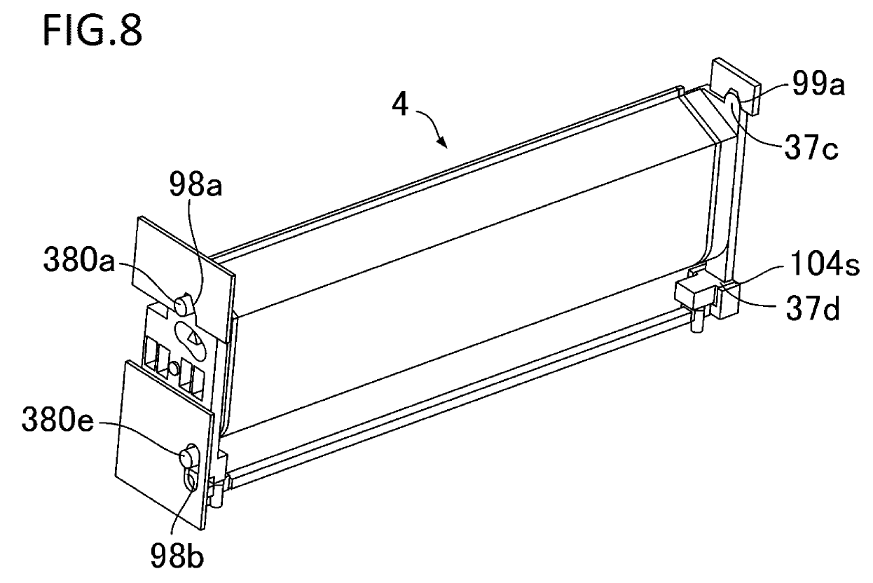

FIG. 8 is a view showing a state where the developing device 4 has been positioned with respect to the body of the image forming apparatus 100. After the developing device 4 as a cartridge has been inserted to the image forming apparatus 100, a near-side positioning portion 37c provided to the near-side end portion member 37 as a supporting member engages with a contacting portion 99a of a near-side plate (not shown) provided to the body of the image forming apparatus 100. A boss 380a provided to the far-side end portion member 38 engages with a contacting portion 98a of a far-side plate (not shown). Accordingly, the developing device 4 is positioned with respect to the body of the image forming apparatus 100.

The near-side end portion member 37 is provided with a rotation stopper 37d for stopping the turn of the near-side end portion member 37 as a supporting member. In a state where the developing device 4 has been inserted to the image forming apparatus 100, the rotation stopper 37d is fitted with a body rotation stopping portion 104s of the body attachment lower guide portion 104. Accordingly, the near-side end portion member 37 can be prevented from turning with respect to the body of the image forming apparatus 100. In a similar manner, the far-side end portion member 38 as a supporting member is provided with a boss 380e for stopping the turn of the far-side end portion member 38. In a state where the developing device 4 has been inserted to the image forming apparatus 100, the boss 380e is fitted with a rotation stopping hole portion 98b of the far-side plate (not shown) provided to the body of the image forming apparatus 100. Accordingly, the far-side end portion member 38 can be prevented from turning within the body of the image forming apparatus 100.

In the above manner, during attachment of the developing device 4 to the body of the image forming apparatus 100, the far-side end portion member 38 and the near-side end portion member 37 as a supporting member are fixed with respect to the body of the image forming apparatus 100. Accordingly, the developing unit 39 in the developing device 4 is made capable of turning with respect to the body of the image forming apparatus 100.

<Description on Contacting and Separating Operation>

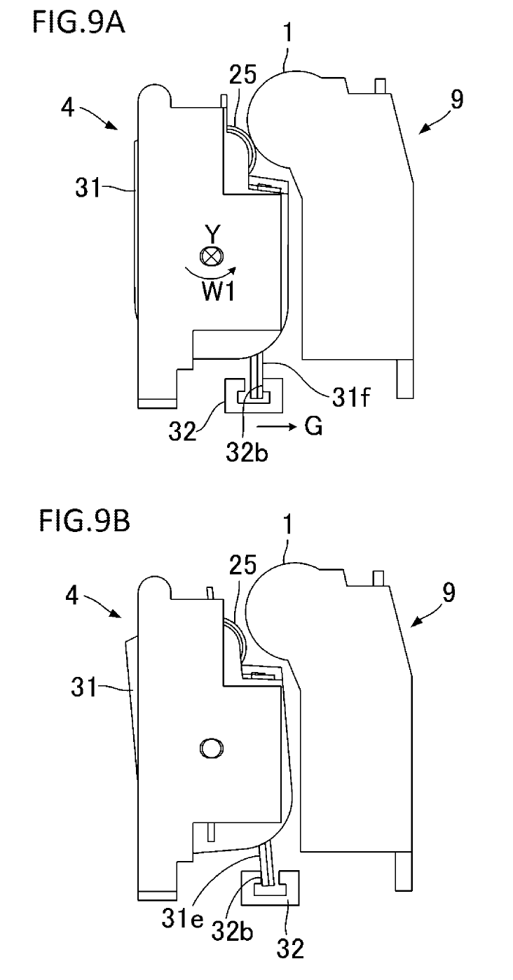

Next, a contacting and separating operation of the photosensitive drum 1 and the developing roller 25 according to this embodiment will be described. FIGS. 9A and 9B are views showing the developing roller 25 and the photosensitive drum 1 separating. In this embodiment, as shown in FIG. 9A, the image forming apparatus 100 is provided with a pressing member 32 as a urging member, in a predetermined position in a direction in which the developing device 4 is attached to or detached from the body of the image forming apparatus 100. When the pressing member 32 moves in an arrow G direction, a contacting force pressurization portion 32a of the pressing member 32 and a contacting force receiving portion 31f of the developing frame body 31 are released from a contacting state. When the pressing member 32 moves further in the arrow G direction, a separating force pressurization portion 32b of the pressing member 32 and a separating force receiving portion 31e of the developing frame body 31 come into contact. When the pressing member 32 moves further in the arrow G direction, the developing unit 39 as a cartridge body turns in an arrow W1 direction (to one side in a turning direction) about the central axis of rotation Y. Accordingly, the developing roller 25 and the photosensitive drum 1 are brought to a separated state (see FIG. 9B).

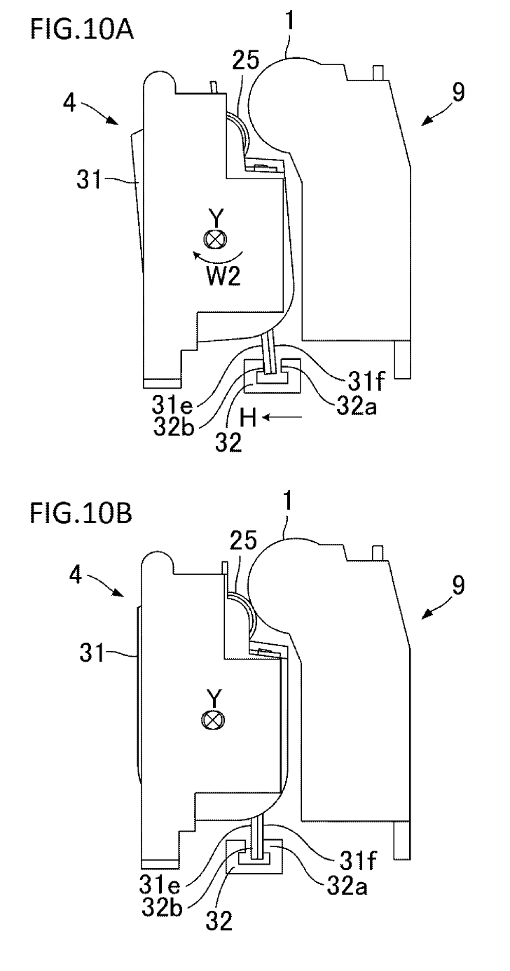

FIGS. 10A and 10B are views showing the developing roller 25 and the photosensitive drum 1 coming into contact. When the pressing member 32 as a urging member capable of urging the developing frame body 31 moves in an arrow H direction, as shown in FIG. 10A, the separating force pressurization portion 32b of the pressing member 32 and the separating force receiving portion 31e of the developing frame body 31 are released from a contacting state. When the pressing member 32 moves further in the arrow H direction, the contacting force pressurization portion 32a of the pressing member 32 and the contacting force receiving portion 31f of the developing frame body 31 come into contact to turn the developing unit 39 in an arrow W2 direction about the central axis of rotation Y. When the pressing member 32 moves further in the arrow H direction, the developing roller 25 and the photosensitive drum 1 are brought to a contacting state (see FIG. 10B). That is, in a state where the developing device 4 has been attached to the body of the image forming apparatus 100, the developing roller 25 is urged by the pressing member 32 in the W2 direction. Accordingly, the developing roller 25 presses the photosensitive drum 1 provided to the drum cartridge 9 that is attachable to and detachable from the body of the image forming apparatus 100.

After the developing roller 25 and the photosensitive drum 1 has come into contact, a pressurizing mechanism (not shown) provided to the pressing member 32 as a urging member causes the developing roller 25 to press the photosensitive drum 1 with a predetermined pressure. In the case of forming an image on the recording medium S, the developing roller 25 and the photosensitive drum 1 are caused to come into contact by such a mechanism to cause the developing roller 25 and photosensitive drum 1 to come into contact or separate. In the case of not forming an image on the recording medium S, the developing roller 25 and the photosensitive drum 1 are caused to separate. Accordingly, deterioration in image quality due to a deformation of the developing roller 25 can be prevented.

<Configuration to Restrict Turn of Developing Unit 39>

As described above, the photosensitive drum 1 and the developing roller 25 are caused to come into contact by the developing unit 39 being pressed by the pressing member 32 included in the body of the image forming apparatus 100. During an image forming operation, a jam (paper jam) or the like may occur. In that case, the drum cartridge 9 may be detached, in a state where the developing roller 25 and the photosensitive drum 1 are in contact due to the developing unit 39 being pressed by the pressing member 32. At this time, the developing roller 25 rotates beyond the position in which the developing roller 25 and the photosensitive drum 1 have been in contact. By the turn of the drum cartridge 9 that has been restricting the turn of the developing unit 39, there is a risk of the developing roller 25 colliding with a part or the like provided to the body of the image forming apparatus 100. When this causes damage in the developing roller 25, there is a risk that the quality of an image formed on the recording medium S is deteriorated by a reduced performance of the developing roller 25.

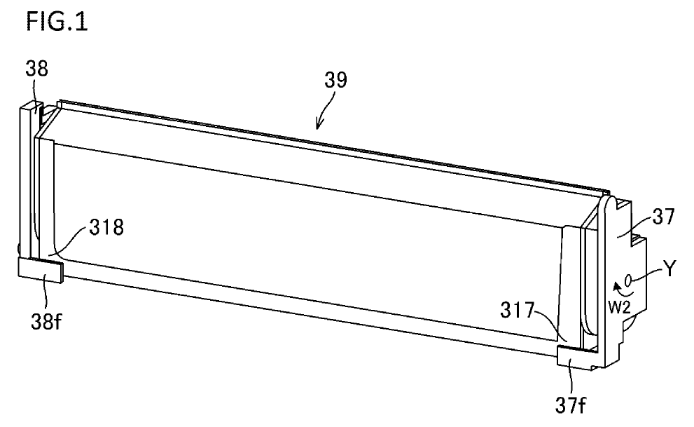

FIG. 1 is an external perspective view of the developing device 4 according to the embodiment. In this embodiment, as shown in FIG. 1, the near-side end portion member 37 as a supporting member is provided with a rotation restricting portion 37f as a restricting member extending toward the developing unit 39 as a cartridge body. In a similar manner, the far-side end portion member 38 as a supporting member is provided with a rotation restricting portion 38f extending toward the developing unit 39. The rotation restricting portion 37f as a restricting member is a protruding portion provided to the near-side end portion member 37, and the rotation restricting portion 38f as a restricting member is a protruding portion provided to the far-side end portion member 38. A part of the rotation restricting portion 37f and the rotation restricting portion 38f is located within an area in which the developing unit 39 turns with respect to the near-side end portion member 37 and the far-side end portion member 38.

In a state where the developing device 4 as a cartridge has been attached to the body of the image forming apparatus 100, the rotation restricting portion 37f as a restricting member protrudes in a direction of insertion of the developing device 4 to the body of the image forming apparatus 100. In a state where the developing device 4 has been attached to the body of the image forming apparatus 100, the rotation restricting portion 38f as a restricting member protrudes in a direction of detachment of the developing device 4 from the body of the image forming apparatus 100. As described above, when the developing unit 39 is pressed by the pressing member 32 provided to the body of the image forming apparatus 100, the developing unit 39 turns in the arrow W2 direction about the central axis of rotation Y.

However, in this embodiment, the rotation restricting portion 37f and the rotation restricting portion 38f restrict the turn of the developing unit 39, at the time of the developing unit 39 turning beyond a contacting position in which the photosensitive drum 1 and the developing roller 25 have been in contact. By a restricted portion 317 and the rotation restricting portion 37f coming into contact and a restricted portion 318 of the developing unit 39 and the rotation restricting portion 38f coming into contact, the developing roller 25 can be prevented from colliding with a part or the like provided to the body of the image forming apparatus 100. In the case where a contacting portion of the developing roller 25 to be in contact with the photosensitive drum 1 is beyond, in the W2 direction, the contacting position in which the developing roller 25 and the photosensitive drum 1 are to be in contact, the near-side end portion member 37 and the far-side end portion member 38 restrict the turn of the developing unit 39.

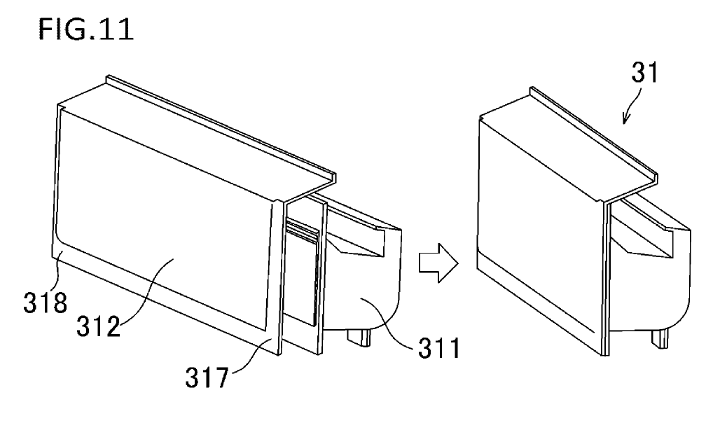

In this embodiment, as shown in FIG. 11, the developing frame body 31 in the developing unit 39 as a cartridge body is configured of a plurality of members of a first frame body 311 and a second frame body 312. In the developing frame body 31, the members that are the first frame body 311 and the second frame body 312 are firmly joined through welding. In the developing frame body 31, a portion in which the first frame body 311 and the second frame body 312 are welded is thicker than a portion in which the first frame body 311 and the second frame body 312 are not welded.

In this embodiment, in the developing unit 39, the restricted portion 317 and the restricted portion 318 are arranged near the portion (a welded portion) in which first frame body 311 and the second frame body 312 are welded. Accordingly, in the developing unit 39, the stiffness of the restricted portion 317 and the restricted portion 318 is enhanced. In the developing frame body 31, the stiffness of the portion in which the first frame body 311 and the second frame body 312 are welded is higher than the stiffness of the portion in which the first frame body 311 and the second frame body 312 are not welded. The near-side end portion member 37 and the far-side end portion member 38 are caused to be in contact with a high-stiffness portion in the developing frame body 31, and therefore, the turn of the developing unit 39 can be stably prevented.

In the above manner, in this embodiment, the near-side end portion member 37 and the far-side end portion member 38 include the rotation restricting portion 37f and the rotation restricting portion 38f to restrict the turn of the developing unit 39 with respect to the near-side end portion member 37 and the far-side end portion member 38, against the pressing force (urging force) of the pressing member 32. Accordingly, the developing roller 25 can be prevented from being damaged.

In this embodiment, in the developing unit 39, the stiffness of a portion in which the rotation restricting portion 37f and the rotation restricting portion 38f make contact is higher than the stiffness of a portion in which the rotation restricting portion 37f and the rotation restricting portion 38f do not make contact. Accordingly, the turn of the developing unit 39 with respect to the near-side end portion member 37 and the far-side end portion member 38 can be stably restricted.

While the rotation restricting portion 37f and the rotation restricting portion 38f are provided to the developing device 4 in this embodiment, this is not necessarily limiting. For example, the configuration may be such that the photosensitive drum 1 is made capable of coming into contact with and separating from (capable of coming into contact with and capable of separating from) the developing roller 25 by the turn of a part of the drum cartridge 9. The rotation restricting portion 37f and the rotation restricting portion 38f may be provided to the drum cartridge 9.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2016-037094, filed on Feb. 29, 2016, and No. 2017-026447, filed on Feb. 15, 2017, which are hereby incorporated by reference herein in their entirety.

What is claimed is:

1. A developing cartridge made capable, together with a drum cartridge including a photosensitive drum, of being each attached to and detached from an image forming apparatus, and including a developer carrier, the developing cartridge comprising:
a cartridge body including the developer carrier;
a first supporting member provided to one end of the developer carrier in an axial direction and a second supporting member provided to another end in the axial direction to support the cartridge body to be capable of turning, such that the developer carrier is made capable of coming into contact with the photosensitive drum; and
a restricting member that restricts a turn of the cartridge body with respect to the first supporting member, when the developing cartridge has been attached to the image forming apparatus, the first supporting member and the second supporting member have been positioned in a body of the image forming apparatus, and the cartridge body has been urged in one direction in a turning direction.

2. The developing cartridge according to claim 1, wherein, in a state where the developing cartridge has been attached to the body, the cartridge body is made capable of turning about a central axis of rotation that extends in a direction in which the developing cartridge is attached to or detached from the body.

3. The developing cartridge according to claim 2, wherein a central axis of rotation of the developer carrier is parallel to the central axis of rotation of the cartridge body.

4. The developing cartridge according to claim 1, wherein the restricting member restricts the turn of the cartridge body with respect to the first supporting member, in a case where a contacting portion of the developer carrier to be in contact with the photosensitive drum is beyond a contacting position in which the developer carrier and the photosensitive drum are to be in contact in the one direction in which the developer carrier is urged by a urging member, in a state where the drum cartridge has been detached from the body.

5. The developing cartridge according to claim 1, wherein the restricting member is a protruding portion provided to the first supporting member.

6. The developing cartridge according to claim 1, wherein the turn of the cartridge body with respect to the first supporting member is restricted by a part of the restricting member being located in an area in which the cartridge body turns with respect to the first supporting member.

7. The developing cartridge according to claim 1, wherein the restricting member comes into contact with the cartridge body to restrict the turn of the cartridge body with respect to the first supporting member.

8. The developing cartridge according to claim 7,
wherein the cartridge body includes a welded portion in which a plurality of members are welded, and
wherein the restricting member comes into contact with the welded portion.

9. The developing cartridge according to claim 1, wherein the first supporting member and the second supporting member are respectively provided to two end sides of the cartridge body in a direction in which a cartridge is attached to or detached from the body.

10. The developing cartridge according to claim 1 that is attachable and detachable with respect to the body in a direction of a central axis of rotation of the developer carrier.

11. The developing cartridge according to claim 1, wherein the restricting member is a protruding portion provided to each of the first supporting member and the second supporting member.

12. An image forming apparatus comprising:
a drum cartridge including a photosensitive drum;
the developing cartridge according to claim 1 with which an electrostatic latent image formed on the photosensitive drum is developed as a developer image with a developer carried by the developer carrier; and
the body that allows attachment and detachment of the drum cartridge and the developing cartridge,
the developer image formed on the photosensitive drum being transferred onto a recording medium to form an image on the recording medium.
